(19) United States
(12) Patent Application Publication
(10) Pub. No.: US 2008/0189649 A1
(43) Pub. Date: Aug. 7, 2008

(54) DISPLAY IMAGE CONTROL APPARATUS AND CONTROL METHOD THEREOF

(75) Inventor: Toru Kikuchi, Hino-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/018,340

(22) Filed: Jan. 23, 2008

(30) Foreign Application Priority Data
Feb. 6, 2007 (JP) 2007-027370

(51) Int. Cl. G06F 3/048

(52) U.S. Cl. 715/781

(57) ABSTRACT

Pieces of attribute information classified as a first attribute type are stored as a sequence in a predetermined sorting order in a memory. Pieces of attribute information classified as a second attribute type different from the first attribute type, and the stored predetermined sorting order are stored in the memory in association with each other. A display window of a plurality of contents is generated based on the sequence in the predetermined sorting order which is associated with attribute information assigned to an arbitrary content, upon displaying the arbitrary content.

### BACKGROUND OF THE INVENTION

1. Field of the Invention

The present invention relates to a technique for displaying a plurality of contents according to a sequence based on attribute information assigned to each content.

2. Description of the Related Art

In recent years, digital home electric appliances such as digital cameras, digital video cameras, digital video disk recorders, low-profile television sets, and the like are increasingly prevailing. These digital home electric appliances allow users to create or browse content data such as still images, moving images, and the like.

Also, some digital home electric appliances cooperate with personal computers (PCs) via set-top boxes (STBs) or the like to allow users to browse document data, presentation data, graphic data, and the like created using the PCs.

Along with the prevalence of large-capacity, low-price storage media, the number of these contents continues to increase.

In order to allow the user to browse such ever-increasing contents using digital home electric appliances, a simple and efficient browse method is demanded.

In order to allow the user to efficiently use contents, a method of extracting related information from additional information added to images to form groups of pieces of extracted related information, displaying images for respective groups, and allowing the user to quickly and easily find a desired image is known. Refer to Japanese Patent Laid-Open No. 2004-013575.

Also, a method of hierarchizing data using a thesaurus dictionary, calculating the importance levels of keywords applicable to respective hierarchized classes, sorting data in each class based on the importance levels, and displaying data in descending order of importance level is known. See Japanese Patent Laid-Open No. 2004-139401.

Furthermore, a method of calculating the total numbers of keywords, which match classes, sorting data based on the total numbers, and displaying data in descending order of the total number of registered keywords is known. See Japanese Patent Laid-Open No. 2004-139401.

However, in these related arts, since the sorting order of classes is fixed, if the sorting order is not suited to browsing, the moving amounts of scrolling and page jumps increase.

For example, assume that information of a person as an object is appended as attribute information to each image content, and image contents are sorted in a personal order. When a certain user wants to browse a content of “Mr. M” as a fishing partner of “Mr. A” while browsing an image content “fishing trip” of “Mr. A”, he or she sorts contents in a personal order, and moves from contents of “Mr. A” to those of “Mr. M”. If image contents are sorted in the alphabetical order or in the order of the Japanese syllabary for the sake of simplicity, many persons may exist between “Mr. A” and “Mr. M”

When a certain user wants to browse a content of “Mr. S” as a friend from school days while browsing an image content “school trip” of “Mr. A”, he or she similarly sorts image contents in a personal order, and moves from contents of “Mr. A” to those of “Mr. S”. In this case, similarly, a large moving amount may be required.

### SUMMARY OF THE INVENTION

It is an object of the present invention to generate a display window by associating attribute information of an arbitrary attribute type to the sorting order of attribute information of another attribute type, and sorting a plurality of contents based on the sorting order.

According to one aspect of the present invention, there is provided a method of controlling a display image control apparatus for displaying a plurality of contents according to a sequence based on attribute information assigned to each content, comprising: storing pieces of attribute information classified as a first attribute type as a sequence in a predetermined sorting order in first storage means; storing, in second storage means, pieces of attribute information classified as a second attribute type different from the first attribute type, and the predetermined sorting order stored in the first storage means in association with each other; and generating a display window of the plurality of contents based on the sequence in the predetermined sorting order stored in the first storage means, and the second attribute type associated with the sequence in the sorting order stored in the second storage means upon displaying arbitrary contents.

According to another aspect of the present invention, there is provided a display image control apparatus for displaying a plurality of contents according to a sequence based on attribute information assigned to each content, comprising: first control means for storing pieces of attribute information classified as a first attribute type as a sequence in a predetermined sorting order in first storage means; second control means for storing, in second storage means, pieces of attribute information classified as a second attribute type different from the first attribute type, and the predetermined sorting order stored in the first storage means in association with each other; and generation means for generating a display window of the plurality of contents based on the sequence in the predetermined sorting order stored in the first storage means, and the second attribute type associated with the sequence in the sorting order stored in the second storage means upon displaying arbitrary contents.

Further features of the present invention will become apparent from the following description of exemplary embodiments with reference to the attached drawings.

### BRIEF DESCRIPTION OF THE DRAWINGS

FIG. 1 is a block diagram showing an example of the hardware arrangement of a data browsing apparatus according to the first embodiment;

FIG. 2 is a block diagram showing an example of the functional arrangement of the data browsing apparatus according to the first embodiment;

FIG. 3 shows an example of a user interface window according to the first embodiment;

FIG. 4 is a view showing an example of an infrared remote controller 120 according to the first embodiment;

FIG. 5 is a table showing an example of content information according to the first embodiment;

FIG. 6 is a view showing an example of sorting order information according to the first embodiment;

FIG. 7 is a table showing an example of associating information according to the first embodiment;

FIG. 8 is a view showing an example of a content sequence according to the first embodiment;

FIG. 9 is a flowchart showing the processing of a display window control unit 204 according to the first embodiment;

FIG. 10 is a block diagram showing an example of the functional arrangement of a data browsing apparatus according to the second embodiment;

FIG. 11 is a view showing an example of personal group information according to the second embodiment;

FIG. 12 is a view showing an example of sorting order information according to the second embodiment;

FIG. 13 is a block diagram showing an example of the functional arrangement of a data browsing apparatus according to the third embodiment;

FIG. 14 is a view showing an example of event group information according to the third embodiment; and

FIG. 15 is a view showing an example of associating information according to the third embodiment.

### DESCRIPTION OF THE EMBODIMENTS

The best mode of carrying out the invention will be described in detail hereinafter with reference to the accompanying drawings. Note that the embodiments to be described hereinafter will exemplify, as a display image control apparatus, a data browsing apparatus which allows the user to browse a desired content by displaying a plurality of contents.

### First Embodiment

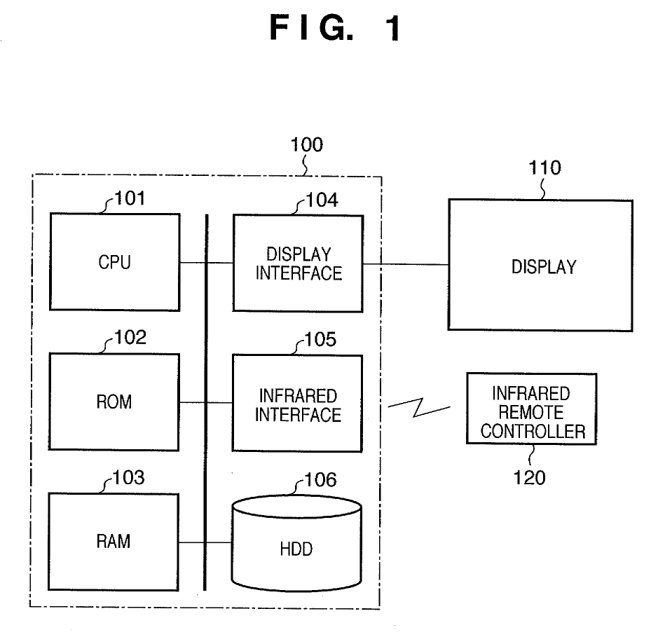

FIG. 1 is a block diagram showing an example of the hardware arrangement of a data browsing apparatus according to the first embodiment. As shown in FIG. 1, a data browsing apparatus 100 comprises a CPU 101, ROM 102, RAM 103, display interface 104, infrared interface 105, and hard disk drive (HDD) 106.

The CPU 101 executes processing programs to be described later and controls the overall data browsing apparatus 100 under the control of an operating system (to be abbreviated as an OS hereinafter). The ROM 102 stores programs to be executed by the CPU 101 upon power ON and various control data. Respective processing programs, various device drivers, and the like are mapped on the RAM 103 upon execution, and are executed by the CPU 101.

The display interface 104 converts window information from a display driver (not shown) into a signal that a display 110 can process, and outputs the converted signal. The infrared interface 105 receives an infrared signal from an infrared remote controller 120, and converts it into information that an infrared remote controller driver (not shown) can process.

The HDD 106 stores the OS, processing programs according to the present invention, various kinds of information, device drivers, and the like.

Note that the same reference numerals denote components that were explained using other drawings and a description thereof will not be repeated, unless otherwise specified.

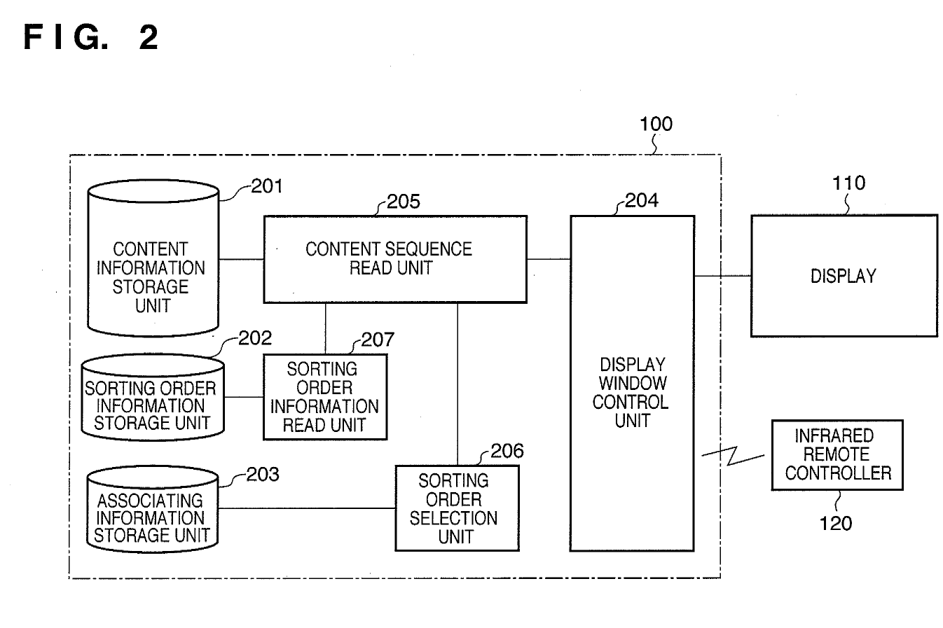

FIG. 2 is a block diagram showing an example of the functional arrangement of the data browsing apparatus according to the first embodiment. As shown in FIG. 2, the data browsing apparatus 100 comprises a content information storage unit 201, sorting order information storage unit 202, associating information storage unit 203, display window control unit 204, content sequence read unit 205, sorting order selection unit 206, and sorting order information read unit 207.

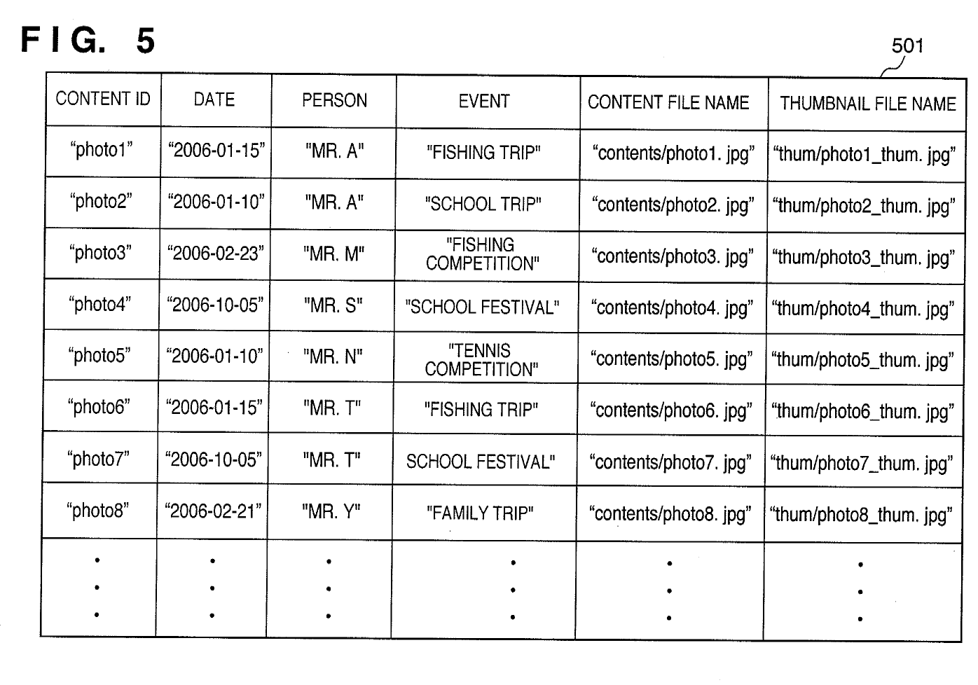

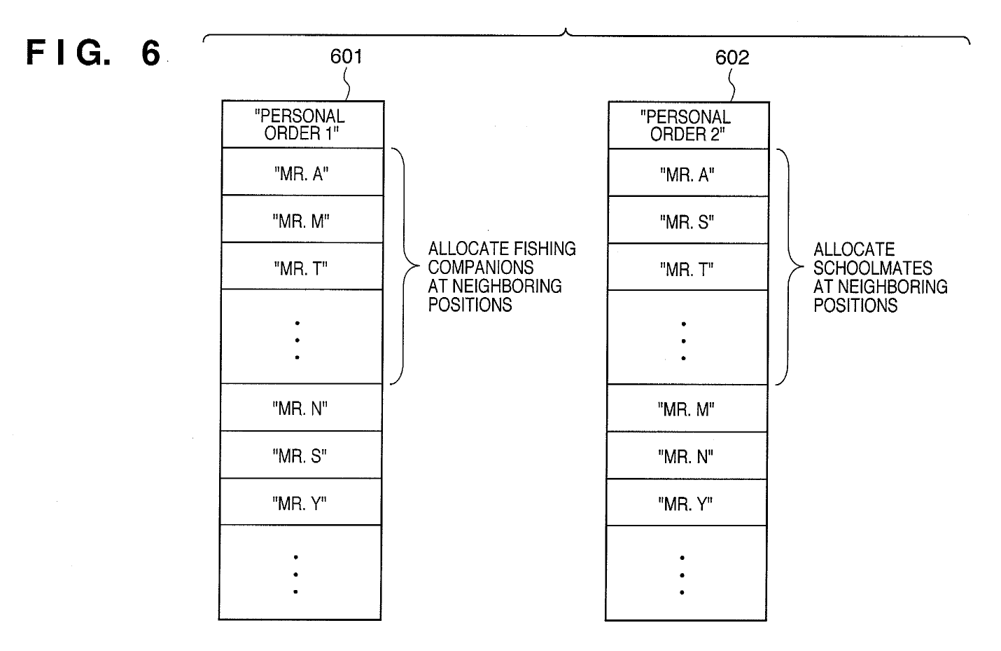

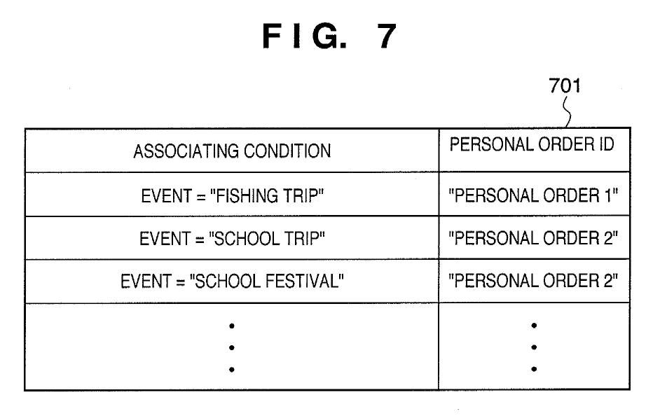

Note that the content information storage unit 201, sorting order information storage unit 202, and associating information storage unit 203 are respectively assured on a storage area of the HDD 106, and respectively store content information (FIG. 5), sorting order information (FIG. 6), and associating information (FIG. 7), which will be described in detail later.

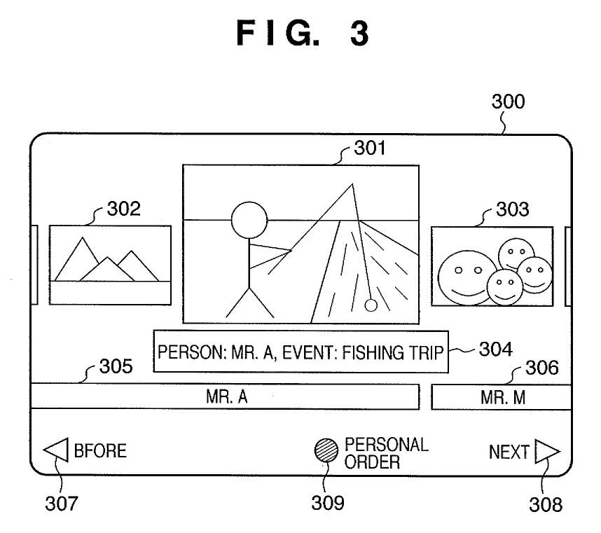

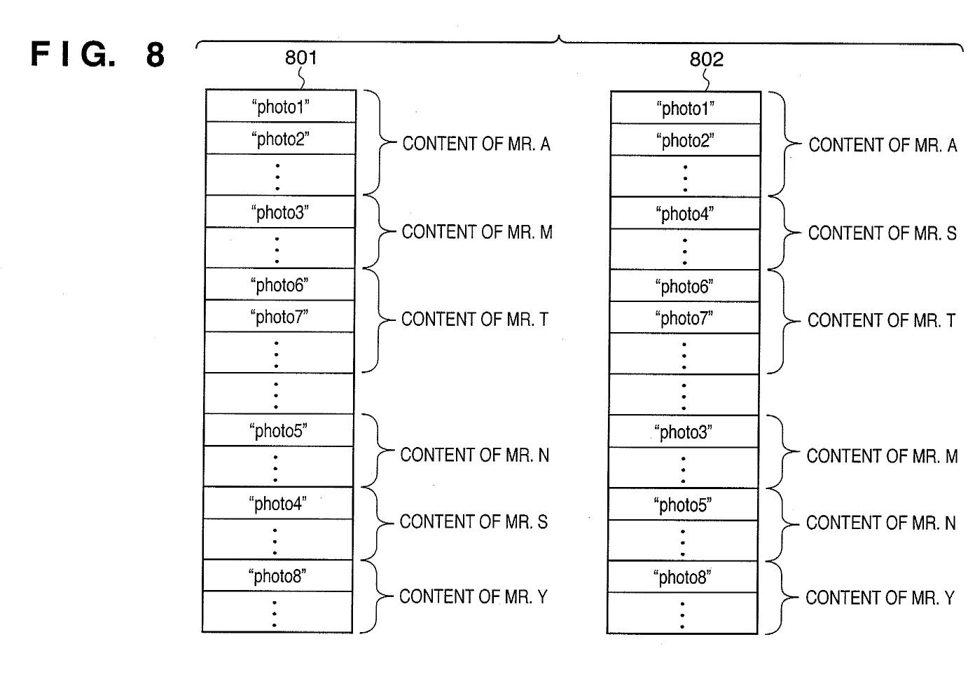

The display window control unit 204 forms a user interface window shown in FIG. 3 based on a content sequence (details of which will be described later with reference to FIG. 8) from the content sequence read unit 205, and displays that window on the display 110. The display window control unit 204 acquires an operation input from the infrared remote controller 120, acquires a content sequence (FIG. 8) via the content sequence read unit 205 according to the operation input, and updates the state of the display window.

The content sequence read unit 205 forms a content sequence (FIG. 8) from content information (FIG. 5) in the content information storage unit 201 in response to a request from the display window control unit 204, and returns it to the display window control unit 204.

Note that the content sequence read unit 205 acquires a personal order ID which identifies a sorting order of persons via the sorting order selection unit 206 based on event attribute information of a content of interest obtained from the display window control unit 204.

The content sequence read unit 205 acquires sorting order information (FIG. 6) from the sorting order information read unit 207 based on the personal order ID selected by the sorting order selection unit 206.

The content sequence read unit 205 acquires content information 501 from the content information storage unit 201 based on the sorting order information (FIG. 6) obtained from the sorting order information read unit 207, and forms a content sequence (FIG. 8).

The sorting order selection unit 206 reads out a personal order ID corresponding to event attribute information designated by the content sequence read unit 205 based on associating information (FIG. 7) stored in the associating information storage unit 203, and returns the readout personal order ID to the content sequence read unit 205.

The sorting order information read unit 207 reads out sorting order information corresponding to the personal order ID (FIG. 6) designated by the content sequence read unit 205 from the sorting order information storage unit 202, and returns the readout information to the content sequence read unit 205.

FIG. 3 shows an example of a user interface window according to the first embodiment. As shown in FIG. 3, thumbnails 301, 302, and 303 are allocated on a user interface window 300 based on a content sequence (FIG. 8), details of which will be described later.

The central thumbnail 301 is displayed to have a size larger than other thumbnails 302 and 303, and a content corresponding to this thumbnail will be referred to as a content of interest hereinafter.

Reference numeral 304 denotes attribute information of the content of interest (thumbnail 301). In this example, personal attribute information is “Mr. A”, and event attribute information is “fishing trip”. Reference numeral 305 denotes attribute information of contents corresponding to the thumbnails 301 and 302, which is personal attribute information “Mr. A” in this example. Reference numeral 306 denotes attribute information of a content corresponding to the thumbnail 303, which is personal attribute information “Mr. M” in this example.

Reference numerals 307 and 308 denote horizontal scroll buttons, which correspond to left and right buttons of the infrared remote controller 120, and are used to horizontally scroll the thumbnails 301, 302, and 303. Reference numeral 309 denotes a “personal order” button which is used to designate whether or not to display contents in the personal order. Assume that designation is switched by turning on/off the “personal order” button 309. Note that a button on the window may be designated using a mouse or the like.

Note that the user interface window 300 is an example, and the same effect can be obtained as long as display based on a sequence of contents is made.

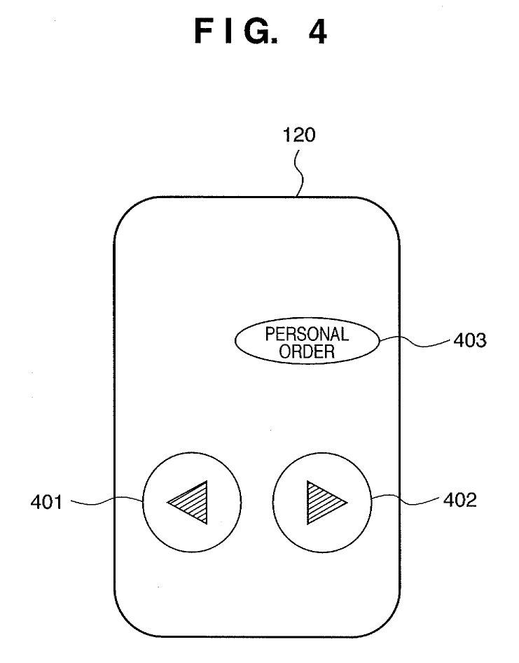

FIG. 4 shows an example of the infrared remote controller 120 according to the first embodiment. The infrared remote controller 120 shown in FIG. 4 comprises a right button 402 used to issue a right scroll instruction, a left button 401 used to issue a left scroll instruction, and a personal order button 403 used to turn on/off personal order display.

Note that the infrared remote controller 120 is an example, and the layout, button names, and the like are not limited to such specific ones.

FIG. 5 shows an example of content information according to the first embodiment. As shown in FIG. 5, content information 501 includes a content ID, attribute information to be classified into attribute types “date”, “person”, and “event”, content file name information, and thumbnail file name information. The content information 501 is stored in the content information storage unit 201.

For example, a content with a content ID “photo1” has “2006-01-15”, “Mr. A”, and “fishing trip” as attribute information to be classified to attribute types “date”, “person”, and “event”. Furthermore, the file name of a file as an entity of the content is “contents/photo1.jpg”, and the file name of a thumbnail is “thum/photo1_thum.jpg”.

Note that the content information 501 of the first embodiment is an example, and the configurations, names, values, and the like of respective pieces of information are not limited to such specific ones.

Also, as attribute types used to classify contents, “date”, “person”, and “event” will be exemplified. However, contents may be classified using other attribute types. Furthermore, each content is displayed using a thumbnail, but it may be displayed using an icon representing that content.

FIG. 6 shows an example of sorting order information according to the first embodiment. As shown in FIG. 6, reference numeral 601 denotes sorting order information indicating the sorting order of persons, which is configured in advance so that “Mr. A”, “Mr. M”, “Mr. T”, . . . as fishing companions are allocated at neighboring positions. In this example, “personal order 1” is assigned as the personal order ID. Reference numeral 602 also denotes sorting order information indicating the sorting order of persons, which is configured in advance so that “Mr. A”, “Mr. S”, “Mr. T”, . . . as friends from school days are allocated at neighboring positions. As in the sorting order information 601, “personal order 2” is assigned as the personal order ID. The sorting order information 601 and sorting order information 602 are stored in the sorting order information storage unit 202.

Note that the sorting order information 601 and sorting order information 602 of the first embodiment are examples, and the conditions for allocating data at neighboring positions, the number of pieces of sorting order information, an expression method of the personal order ID, and the like are not limited to such specific ones.

FIG. 7 shows an example of associating information of the first embodiment. Referring to FIG. 7, reference numeral 701 denotes associating information which includes an associating condition and personal order ID. Note that an associating condition “event”=fishing trip” indicates that attribute information classified as “event” is “fishing trip”. In this example, the sorting order information 601 with a personal order ID “personal order 1” is associated.

Note that the associating information 701 of the first embodiment is an example, and the present invention is not limited to such specific one.

FIG. 8 shows an example of a content sequence according to the first embodiment. Referring to FIG. 8, reference numeral 801 denotes a content sequence based on the sorting order information 601; and 802, a content sequence based on the sorting order information 602.

The content sequence 801 is formed by arranging contents “photo1”, “photo2”, . . . of “Mr. A”, contents “photo3”, . . . of “Mr. M”, . . . in turn according to the sorting order “Mr. A”, “Mr. M”, “Mr. T”, . . . of the sorting order information 601.

The content sequence 802 is formed by arranging contents “photo1”, “photo2”, . . . of “Mr. A” contents “photo4”, . . . of “Mr. S”, . . . in turn according to the sorting order “Mr. A”, “Mr. S”, “Mr. T”, . . . of the sorting order information 602.

That is, the content sequence 801 is formed to display a content which has person attribute information “Mr. A” and event attribute information “fishing trip” as a content of interest, as shown in FIG. 3. Also, the content sequence 802 is formed to display a content which has person attribute information “Mr. A” and event attribute information “school trip (school festival)” as a content of interest.

Note that the content sequences 801 and 802 of the first embodiment are examples, and the present invention is not limited to these specific sequences.

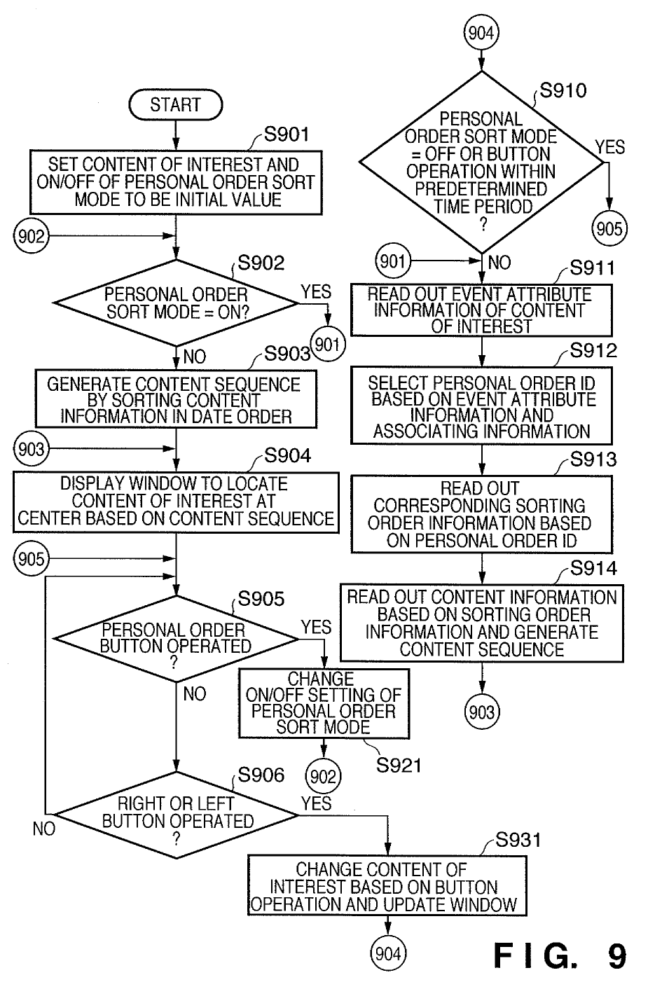

The processing of the display window control unit 204 to be executed by the CPU 101 of the data browsing apparatus 100 will be described below with reference to FIG. 9.

FIG. 9 is a flowchart showing the processing of the CPU 101 according to the first embodiment. When the processing starts, the CPU 101 initially sets a predetermined content or a content, which was displayed as the content of interest in the previous operation, as a content of interest, and sets ON/OFF of a personal order sort mode to be an initial value (e.g., OFF) (S901). The CPU 101 then checks if the personal order sort mode is ON or OFF. If the personal order sort mode is OFF (No in S902), the CPU 101 generates a content sequence formed by sorting the content information 501 in a date order (S903).

On the other hand, if the personal order sort mode is ON in step S902 (Yes in S902), the CPU 101 reads out event attribute information of the content of interest (S911), and selects the personal order ID corresponding to the readout event attribute information based on the associating information 701 (S912). The CPU 101 then reads out the sorting order information 601 or 602 corresponding to that personal order ID (S913), and reads out the content information 501 based on the readout sorting order information 601 or 602, thus generating a content sequence (S914).

Next, the CPU 101 configures the user interface window 300 based on the content sequence generated in step S903 or S914 above so that the content of interest is located at the center, and displays it on the display 110 (S904). After that, upon detection of the operation of a button on the infrared remote controller 120, if that operation is the personal order button 403 (Yes in S905), the CPU 101 changes the ON/OFF setting of the personal order sort mode (S921). The process then returns to step S902.

If the detected operation is not the personal order button 403 in step S905 (No in S905), but if it is the left button 401 or right button 402 (Yes in S906), the CPU 101 changes a content of interest based on the button operation to update the display window (S931). If the personal order sort mode is not OFF, and no button operation is made within a predetermined time period (No in S910), the process advances to step S911 described above.

On the other hand, if the personal order sort mode is OFF or the button operation is detected in step S910 (Yes in S910), the process returns to step S905 described above.

According to the first embodiment, since the content sequence is generated by selecting the sorting order of persons associated with the event of the content of interest, contents can be easily displayed in the personal order, which allocates persons having high relevance to the content of interest.

When the content of interest is changed by scrolling by means of the right or left button operation during display in the personal order sort mode, sorting is automatically done after an elapse of a predetermined period of time, thus obviating the need for a re-display operation.

### Second Embodiment

The second embodiment according to the present invention will be described in detail below with reference to the accompanying drawings. Note that the hardware arrangement is the same as that in the first embodiment described using FIG. 1. The user interface window is the same as that in the first embodiment described using FIG. 3. The infrared remote controller is the same as that in the first embodiment using FIG. 4.

The content information is the same as that in the first embodiment using FIG. 5. The associating information is the same as that in the first embodiment using FIG. 7. The content sequence is the same as that in the first embodiment using FIG. 8. The processing is the same as that in the first embodiment using FIG. 9.

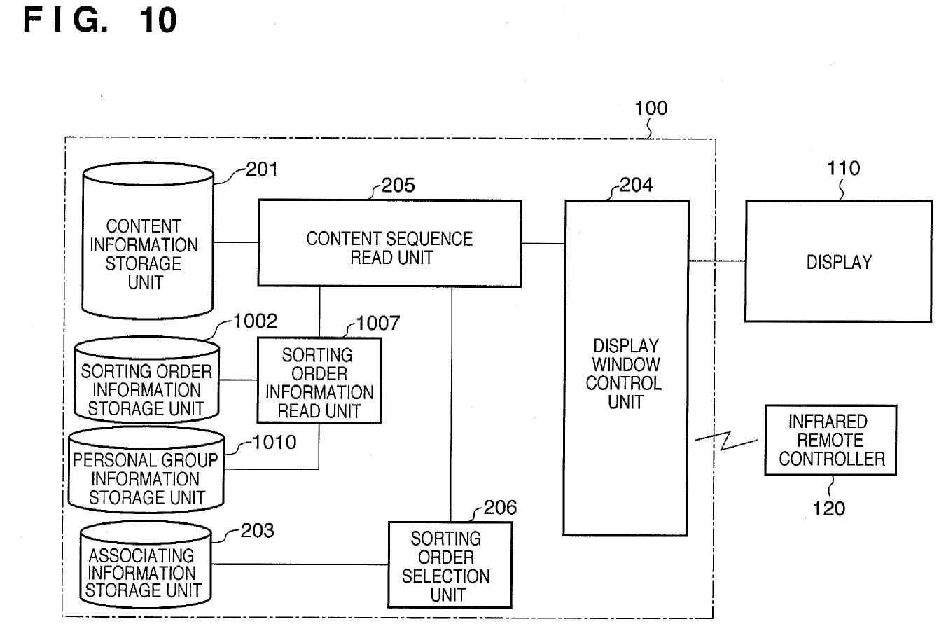

FIG. 10 is a block diagram showing an example of the functional arrangement of a data browsing apparatus according to the second embodiment. As shown in FIG. 10, the data browsing apparatus 100 includes the content information storage unit 201, associating information storage unit 203, display window control unit 204, content sequence read unit 205, and sorting order selection unit 206, which have been described in the first embodiment. Furthermore, the apparatus 100 comprises a sorting order information storage unit 1002, sorting order information read unit 1007, and a personal group information storage unit 1010.

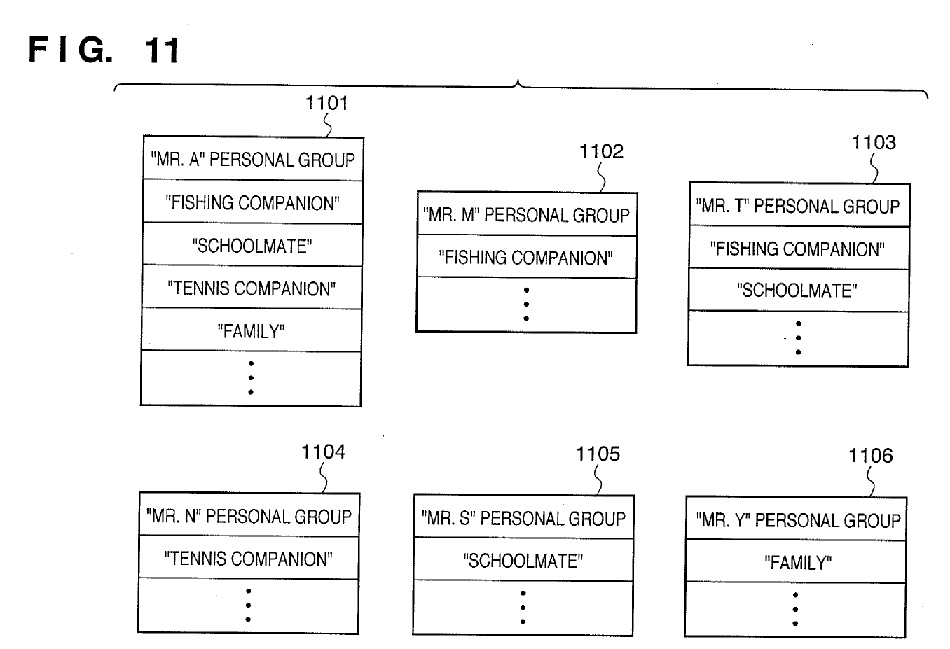

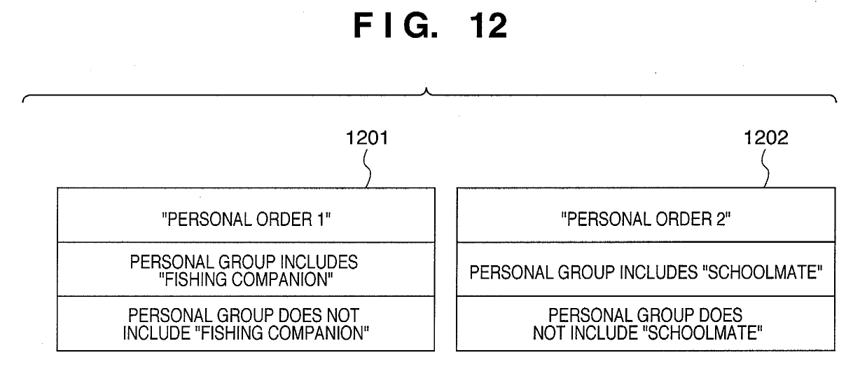

Note that the sorting order information storage unit 1002 and personal group information storage unit 1010 are assured on a storage area of the HDD 106 as in other storage units, and respectively store sorting order information (FIG. 12) and personal group information (FIG. 11), details of which will be described later.

The sorting order information read unit 1007 reads out sorting order information 1201 or 1202 corresponding to the personal order ID from the sorting order information storage unit 1002, updates the sorting order information based on pieces of personal group information 1101 to 1106, and returns the updated sorting order information to the content sequence read unit 205.

In the second embodiments, personal groups to which a certain person belongs are formed for each person, so as to easily add or delete a person.

FIG. 11 shows an example of personal group information according to the second embodiment. Referring to FIG. 11, personal group information 1101 indicates that “Mr. A” belongs to personal groups “fishing companion”, “schoolmate”, “tennis companion”, “family”, . . . , and the same applies to the remaining pieces of information 1102, 1103, 1104, 1105, and 1106.

Note that the pieces of personal group information 1101 to 1106 of the second embodiment are examples, and the present invention is not limited to such specific information. Also, grouping may be specified using a thesaurus dictionary or the like.

FIG. 12 shows an example of sorting order information according to the second embodiment. Referring to FIG. 12, sorting order information 1201 specifies sorting of contents which have the personal order ID “personal order 1” and include “fishing companion” in the personal groups of the personal order, and then of contents which do not include “fishing companion” in the personal groups.

Sorting order information 1202 specifies sorting of contents which have the personal order ID “personal order 2” and include “schoolmate” in the personal groups of the personal order, and then of contents which do not include “schoolmate” in the personal groups.

Actual sorting order information of persons is created as needed based on the sorting order information 1201 or 1202 and the pieces of personal group information 1101 to 1106, as has been described in the first embodiment using FIG. 6.

Note that the sorting order information 1201 and sorting order information 1202 of the second embodiment are examples, and the present invention is not limited to such specific information. For example, combined conditions like “personal groups include ‘fishing companion’ and also ‘schoolmate’” may be used.

According to the second embodiment, since the actual sorting order information of persons are created as needed, the sorting order information stored in the sorting order information storage unit 1002 need not be changed even when persons are added or deleted.

### Third Embodiment

The third embodiment according to the present invention will be described below with reference to the accompanying drawings. Note that the hardware arrangement is the same as that in the first embodiment described using FIG. 1. The user interface window is the same as that in the first embodiment described using FIG. 3. The infrared remote controller is the same as that in the first embodiment using FIG. 4.

The content information is the same as that in the first embodiment using FIG. 5. The sorting order information is the same as that in the first embodiment using FIG. 6. The content sequence is the same as that in the first embodiment using FIG. 8. The processing is the same as that in the first embodiment using FIG. 9.

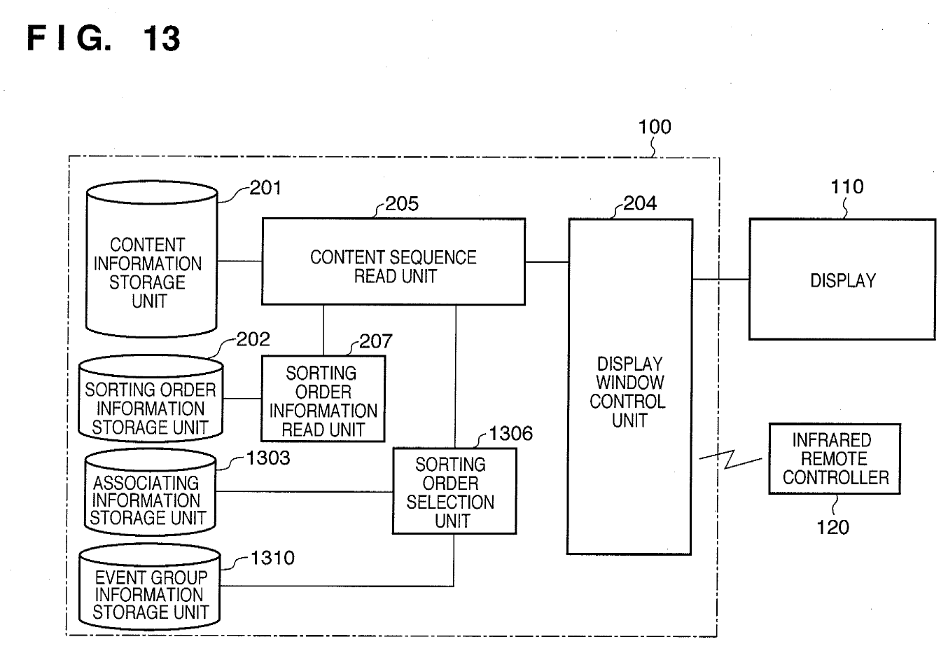

FIG. 13 is a block diagram showing an example of the functional arrangement of a data browsing apparatus according to the third embodiment. As shown in FIG. 13, the data browsing apparatus 100 includes the content information storage unit 201, sorting order information storage unit 202, display window control unit 204, content sequence read unit 205, and sorting order information read unit 207, which have been described in the first embodiment. Furthermore, the apparatus 100 comprises an associating information storage unit 1303, sorting order selection unit 1306, and event group information storage unit 1310.

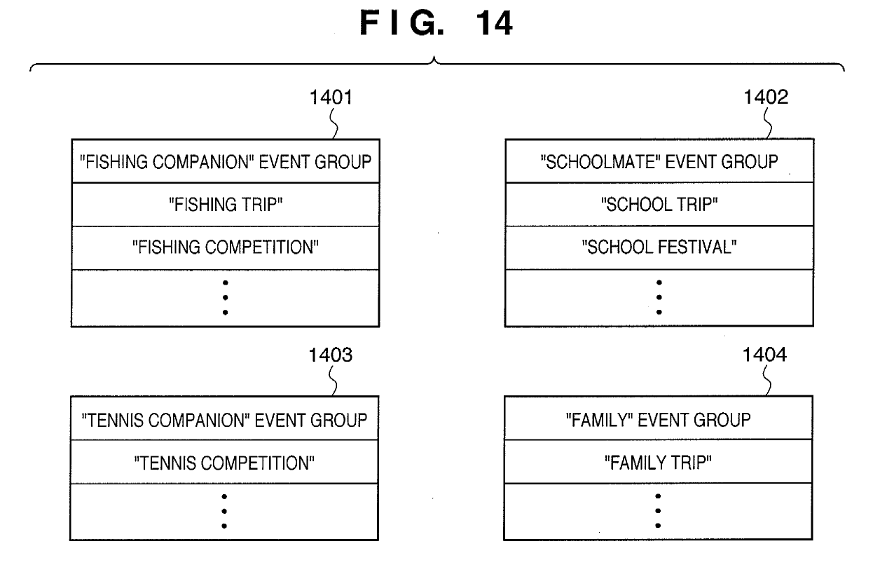

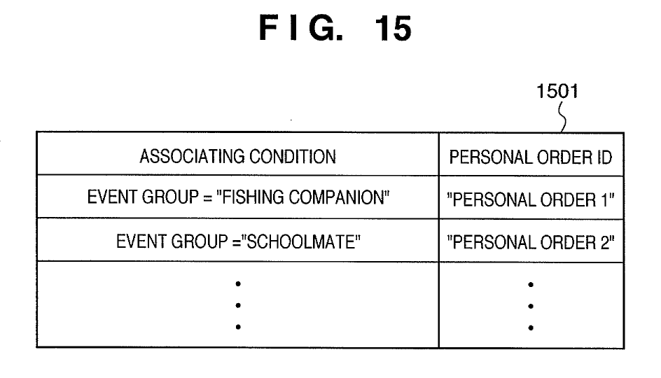

Note that the associating information storage 1303 and event group information storage unit 1310 are assured on a storage area of the HDD 106 as in other storage units, and respectively store associating information (FIG. 15) and event group information (FIG. 14), details of which will be described later.

The sorting order selection unit 1306 reads out a personal order ID corresponding to an event based on pieces of event group information 1401 to 1404 and associating information 1501, and returns the readout personal order ID to the content sequence read unit 205.

In the third embodiments, events are grouped for groups to which persons belong so as to easily add or delete events.

FIG. 14 shows an example of event group information according to the third embodiment. Referring to FIG. 14, event group information 1401 indicates that “fishing trip”, “fishing competition”, . . . belong to a “fishing companion” event group, and the same applies to the remaining pieces of information 1402, 1403, and 1404.

Note that the pieces of event group information 1401 to 1404 of the third embodiment are examples, and the present invention is not limited to such specific information.

FIG. 15 shows an example of associating information according to the third embodiment. Referring to FIG. 15, associating information 1501 includes an associating condition and personal order ID. The information 1501 indicates that events which belong to the “fishing companion” event group are associated with “personal order 1”, and events which belong to a “schoolmate” event group are associated with “personal order 2”.

Note that the associating information 1501 of the third embodiment is an example, and the present invention is not limited to such specific information. Also, grouping may be specified using a thesaurus dictionary or the like.

According to the third embodiment, since event groups and the sorting order information of personal groups are associated with each other, the associating information in the associating information storage unit 1303 need not be changed even when events are added or deleted.

Note that the present invention may be applied to either a system constituted by a plurality of devices (e.g., a host computer, interface device, reader, printer, and the like), or an apparatus consisting of a single device (e.g., a copying machine, facsimile apparatus, or the like).

A recording medium, which records a program code of software that can implement the functions of the aforementioned embodiments, is supplied to the system or apparatus, and a computer (or a CPU or MPU) of the system or apparatus reads out and executes the program code stored in the recording medium. In this way, the objects of the present invention can be achieved.

In this case, the program code itself read out from the recording medium implements the functions of the aforementioned embodiments, and the recording medium which stores the program code constitutes the present invention.

As the recording medium used to supply the program code, for example, a flexible disk, hard disk, optical disk, magneto-optical disk, CD-ROM, CD-R, magnetic tape, nonvolatile memory card, ROM, and the like can be used.

The functions of the aforementioned embodiments can be implemented not only when the computer executes the readout program code but also by the following case. That is, this is the case wherein an OS (operating system) or the like which runs on the computer executes some or all of actual processing operations based on instructions of the program code to implement the functions of the aforementioned embodiments.

Furthermore, the present invention also includes the following case. That is, the program code read out from the recording medium is written in a memory equipped on a function expansion board or function expansion unit, which is inserted in or connected to the computer. After that, a CPU or the like equipped on the function expansion board or unit executes some or all of actual processing operations based on instructions of the program code to implement the functions of the aforementioned embodiments.

According to the present invention, a display window can be generated by associating attribute information of an arbitrary attribute type to the sorting order of attribute information of another attribute type, and sorting a plurality of contents based on the sorting order.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-027370, filed Feb. 6, 2007 which is hereby incorporated by reference herein in its entirety.

What is claimed is:

1. A method of controlling a display image control apparatus for displaying a plurality of contents according to a sequence based on attribute information assigned to each content, comprising:
storing pieces of attribute information classified as a first attribute type as a sequence in a predetermined sorting order in first storage means;
storing, in second storage means, pieces of attribute information classified as a second attribute type different from the first attribute type, and the predetermined sorting order stored in the first storage means in association with each other; and
generating a display window of the plurality of contents based on the sequence in the predetermined sorting order stored in the first storage means, and the second attribute type associated with the sequence in the sorting order stored in the second storage means upon displaying arbitrary contents.

2. The method according to claim 1, further comprising displaying the display window of the plurality of contents generated in the step of generating on display means.

3. The method according to claim 1, wherein the pieces of attribute information classified as the first attribute type are grouped, and the pieces of grouped attribute information are stored in the first storage means as the sequence in the predetermined sorting order.

4. The method according to claim 1, wherein the pieces of attribute information classified as the second attribute type are grouped, and the pieces of grouped attribute information and the predetermined sorting order stored in the first storage means are stored in the second storage means in association with each other.

5. The method according to claim 2, further comprising making a user select an arbitrary content from the display window of the plurality of contents.

6. The method according to claim 5, wherein the step of making the user select makes the user select attribute information classified as the first attribute type as a condition for making the user select the arbitrary content from the display window of the plurality of contents.

7. The method according to claim 1, wherein when a state of the display window of the plurality of contents does not change in a predetermined time period after the state of the display window of the plurality of contents has been changed, the step of generating generates the display window of the plurality of contents.

8. A display image control apparatus for displaying a plurality of contents according to a sequence based on attribute information assigned to each content, comprising:
first control means for storing pieces of attribute information classified as a first attribute type as a sequence in a predetermined sorting order in first storage means;
second control means for storing, in second storage means, pieces of attribute information classified as a second attribute type different from the first attribute type, and the predetermined sorting order stored in the first storage means in association with each other; and
generation means for generating a display window of the plurality of contents based on the sequence in the predetermined sorting order stored in the first storage means, and the second attribute type associated with the sequence in the sorting order stored in the second storage means upon displaying arbitrary contents.

9. A computer-readable recording medium recording a program for causing a computer execute a method of controlling a display image control apparatus according to claim 1.
